(19) United States
(12) Patent Application Publication
(10) Pub. No.: US 2014/0099604 A1
(43) Pub. Date: Apr. 10, 2014

(54) DENTAL MARKING PRODUCT WITH VARYING WIDTHS AND THICKNESSES FOR GAUGING AND MARKING OCCLUSAL CLEARANCE TO FACILITATE FABRICATION AND INSTALLATION OF A DENTAL RESTORATIVE ELEMENT

(71) Applicant: Albert J. Kurpis, Ridgewood, NJ (US)

(72) Inventor: Albert J. Kurpis, Ridgewood, NJ (US)

(21) Appl. No.: 13/647,131

(22) Filed: Oct. 8, 2012

(51) Int. Cl. A61C 5/10

(52) U.S. Cl. 433/223

(57) ABSTRACT

A dental marking product for gauging and marking occlusal clearance between a prepared tooth or teeth and an opposing tooth or teeth or dental restoration to facilitate fabrication and installation of a dental element. The product includes flexible tapes, strips, or paper which include a marking agent. Each strip has a narrow portion at a first end of the strip and a wide portion at a second end of the strip. Each strip has a thickness corresponding to a determined occlusal clearance between the prepared tooth or teeth and the opposing tooth or teeth or dental restoration. The occlusal clearance is determined based on characteristics of the dental element to be fabricated and installed, and the material of which it is formed, on the prepared tooth or teeth. The marking agent marks at least portions of the prepared tooth or teeth or the opposing tooth or teeth or dental restoration which protrude into a gap defined by the determined occlusal clearance.

### FIELD OF THE INVENTION

The disclosed embodiments relate to dental marking product with varying widths and thicknesses. In particular, the disclosed embodiments are directed to a dental marking product with varying widths and thicknesses for gauging and marking occlusal clearance, and interdentician space upon full occlusion, between a prepared tooth or teeth and an opposing tooth or teeth or dental prosthesis to facilitate preparation of a tooth or teeth and the fabrication and installation of a dental restorative element.

### BACKGROUND OF THE INVENTION

Dental restorative elements, such as crowns, inlays, onlays, dental veneers, fixed bridges, dental implant abutments, or other dental restorative elements can be made from different materials, each requiring a different minimum thickness of material to fabricate the element. In order to accommodate these differences, the tooth structure of the corresponding tooth to be covered by the dental element (i.e., the “prepared tooth”) must be reduced by a sufficient amount to allow the dental element fabricated to be of a defined thickness to fit over, or on to, the prepared tooth. If the tooth structure is reduced insufficiently, then the dental element sitting on top of the underprepared tooth will be too high on its bite when the jaw closes into maximum occlusion, i.e., the dental element will hit before all other teeth and will prevent and not allow the other teeth to close into normal tooth contact required for proper chewing function. Also if there is insufficient thickness of material the dental element can fracture or be worn through upon occlusal load or tooth excursion. In other words, the prepared tooth must have sufficient occlusal clearance with respect to the opposing teeth in order to allow for proper fabrication and installation of the dental restorative element, i.e., of a defined minimum thickness to accomplish its design or material from which it is made.

Various conventional means have been used to measure occlusal clearance. For example, many varieties of marking paper (e.g., articulating paper, foils, etc.) have been used to indicate the points of contact between two opposing teeth, or groups of teeth, during mastication and tooth grinding/sliding. The purpose of these marks is to demonstrate to the user of the articulating paper where the point of contact might be when the teeth contact or whether the points of contact are in excess (i.e., “high bite”) so that occlusal disharmonies could be determined and corrected, if necessary.

The markings left by articulating paper are also used when fabricating dental restorations, such as crowns, bridges, fillings, inlays and onlays, to determine the correctness of the biting surfaces in relation to the opposing dentition. Through observation of the location of these marks and the intensity of the color left on the biting surfaces when the paper is placed between teeth and patient is instructed to close their teeth, the marks will provide an opportunity to further evaluate a dental restoration and make any appropriate changes if necessary. Articulating paper can also be stacked upon itself with multiple pieces to evaluation the inter-occlusal distance between a prepared tooth and the opposing dentition. However, the use of articulating paper for this purpose can be inconvenient and cumbersome, because a piece, or several pieces, of the paper may need to be folded or stacked and held with forceps in order to achieve a necessary total thickness. Articulating papers and foils are manufactured to measure parts of teeth when in contact, rather than the space between a prepared tooth or teeth and the opposing tooth or teeth. Furthermore, use of multiple pieces of stacked articulating paper, of unknown thickness, is not an accurate way to determine precise tooth reduction necessary to fabricate or install a dental restorative element.

Another conventional measurement means, referred to as FlexTab Flexible Clearance Tabs, are made of a soft, flexible material of predetermined thickness that can be placed between a prepared tooth or teeth and the opposing dentition to determine the distance between a prepared tooth or teeth and the opposing dentition. When the teeth are closed, the occlusal clearance provides resistance to the pulling of the FlexTab Flexible Clearance Tabs out from the space between the prepared tooth or teeth and the opposing dentition. If the tabs cannot easily be removed when the teeth are closed in occlusion, then it is determined that there is not enough reduction of the prepared tooth to accommodate the thickness of dental material that will be necessary to fabricate a dental element. These tabs do not include any marking substance, making it impossible for the dentist to determine which portion of the tooth is underprepared and needs further occlusal reduction. The dentist must arbitrarily reduce the tooth in order to achieve adequate occlusal clearance and this can lead to over-reduction of some portions of the tooth. Another measurement means, referred to as PrepCheck, is also a soft, flexible material of predetermined thickness that can be placed between a prepared tooth or teeth and the opposing dentition to determine the distance between a prepared tooth or teeth and the opposing dentition. These tabs include a marking substance on one end of the tab. However, marking tabs of this type tend to be relatively expensive and individually packaged, which is inconvenient and costly for the dentist. In addition, the rubber material these tabs are made out of is hard to cut making them difficult to customize to accommodate variations in tooth size and shape. Furthermore, the tab's curved, non-linear shape makes it difficult to use in situations where multiple prepared teeth over a linear span need to be tested for occlusal clearance simultaneously. Finally, the marking substance comes off the tab easily making subsequent occlusal checks with the same tab difficult to accurately read. Therefore the dentist would have to use multiple individually packaged tabs, which is inconvenient and an economic burden.

### SUMMARY OF THE INVENTION

The disclosed embodiments are directed to a dental occlusal clearance tape, strips, or paper, which has a determined thickness based on the particular interarch reduction necessary for a specific dental element to be fabricated and installed. It is coated with or impregnated with an indicating marking substance or agent, e.g., ink, pigment, dye, colorant, etc., which is squeezed out or rubbed off onto the opposing tooth structure or dental restoration and/or the prepared tooth. This visual aid helps the dentist to locate areas of inadequate tooth reduction which can then be further reduced. This helps to ensure that enough tooth structure is reduced in all necessary locations on the surface of the prepared tooth when closing into a maximum occlusion or grinding in left and right lateral protrusive excursions so that a dental element of a required specific thickness can be correctly fabricated and installed.

In one aspect of the disclosed invention, a dental marking product is provided for gauging and marking occlusal clearance between a prepared tooth or teeth and an opposing tooth or teeth or dental restoration to facilitate fabrication and installation of a dental element. The product includes flexible pieces of dental tape, strips, or papers which include a marking agent. Each strip has a narrow portion of a first width at a first end of the strip and a wide portion of a second width, which is wider than the first width, at a second end of the strip. Each strip has a thickness corresponding to a determined thickness which is necessary for occlusal clearance between the prepared tooth or teeth and the opposing tooth or teeth or dental restoration. The necessary occlusal clearance is determined based on characteristics of the dental element to be fabricated and installed on the prepared tooth or teeth or the material of which the dental element is to be made. The marking agent marks those portions of the prepared tooth or teeth or the opposing tooth or teeth or dental restoration which protrude into a gap defined by the determined necessary occlusal clearance.

Embodiments of the disclosed invention may include one or more of the following features. The strips may be provided in the form of a continuous roll. The product may include a dispenser configured to hold the continuous roll and output individual strips from the continuous roll one strip at a time. Individual strips of the continuous roll may be divided by serrations. The strips may be provided as separate individual strips. The product may include a dispenser configured to hold a stack of the separate individual strips and output the individual strips from the stack one strip at a time or in groups

The narrow portion and the wide portion of each strip may extend over about one half of a length of the strip. Each strip may include a tapered portion between the narrow portion and the wide portion. The strips may have a thickness of between 1.0 mm and 2.5 mm. The strips may have a thickness of one of 1.0 mm, 1.5 mm, 2.0 mm, and 2.5 mm. The strips may be color coded to correspond to the thickness of the strips. The first width of the strips may be between about 3 mm and about 5 mm, and the second width of the strips may be between about 5 mm and about 8 mm. The first width may be between about 4 mm and about 5 mm, and the second width may be between about 6.5 mm and about 7.5 mm.

The strips may be formed of least one of coated paper, fiber-reinforced paper, micro-fleece paper, rubber, and plastic. The marking agent may be at least one of color pigment, dye, micronized color pigment, powdered colorant, or ink.

### BRIEF DESCRIPTION OF THE DRAWINGS

The above and/or other aspects and advantages will become more apparent and more readily appreciated from the following detailed description of the disclosed embodiments taken in conjunction with the accompanying drawings of which:

FIG. 1 depicts an occlusal clearance dental marking product being inserted between a prepared tooth and an opposing tooth, in accordance with a first embodiment of the present invention;

FIG. 2 depicts a detailed view of the occlusal clearance dental marking product being inserted between a prepared tooth and an opposing tooth;

FIG. 3 depicts a continuous roll of occlusal clearance dental marking product divided into strips by serrated boundaries; and

FIG. 4 depicts a dispenser configured to hold a continuous roll of occlusal clearance dental marking product and output individual strips of the tape.

FIG. 5 depicts an individual dispensed strip of occlusal clearance dental marking product.

FIG. 6 depicts a dispenser configured to hold and output individual strips of occlusal clearance dental marking product.

### DETAILED DESCRIPTION OF THE DRAWINGS

A “prepared tooth” is a tooth which has had tooth structure removed by a dental drill in order to accommodate a full or partial coverage dental restoration, such as a dental crown, inlay, onlay, ¾ crown, dental veneer, implant abutment or other dental restorative element. The preparation typically involves reducing the tooth by an amount equal to the thickness of the restorative element to be affixed to the prepared tooth, e.g., the thickness of the material necessary to fabricate the dental element. It is important to ensure that the prepared tooth is accurately reduced by the amount needed for the restorative element over its entire surface without under or over-reducing the prepared tooth.

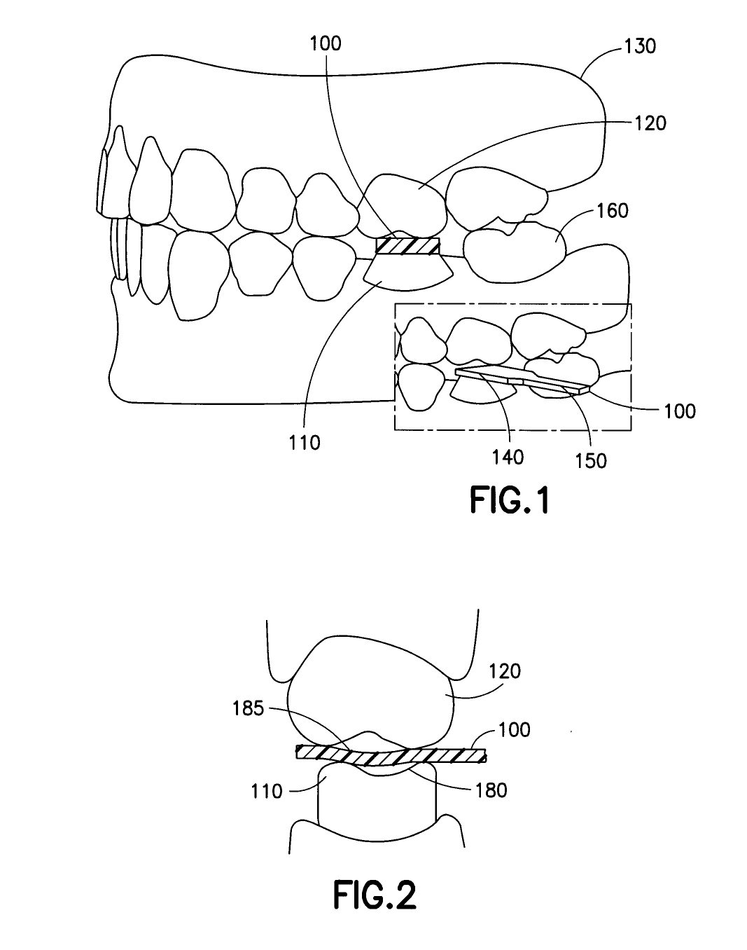

As shown in FIG. 1, in an embodiment of the present invention, a strip 100 of occlusal clearance dental marking product may be inserted to gauge the distance between the prepared tooth (or teeth) 110 and the opposing tooth or teeth or dental restoration 120 when the patient's jaw 130 is closed, i.e., the occlusal clearance. The occlusal clearance dental marking product helps the dentist to confirm that the correct occlusal clearance is achieved during the preparation process.

The occlusal clearance strip/tape/paper is a soft, flexible substance which can be fabricated in different widths, thicknesses, and lengths and which contains a marking agent. The marking agent, as described in further detail below, provides a visual indication to the dentist, e.g., in the form of colored markings left on the surface of the tooth or teeth, of specific portions of the prepared tooth which do not meet the required minimum occlusal clearance. The marking agent is transferred to the surface of the prepared tooth and the opposing tooth or teeth or dental restoration at points where there is inadequate occlusal clearance to accommodate the thickness of a dental restorative element. This is accomplished by having the patient bite down and/or grind on the strip/tape/paper. The marking agent is provided on both surfaces of the strip/tape/paper so that markings are left both on the prepared tooth or teeth and the opposing tooth or teeth or dental restoration.

Each piece 100 of the dental marking product may have a wider width portion 140 at one end and a narrower width portion 150 at the other end. The wider portion 140 of the strip 100 can be used for wider teeth, such as molars 160. In such cases, the strip can be held by the narrower portion 150, either by hand or using a dental instrument, such as forceps. For narrower teeth, such as bicuspids or anterior teeth, the strip 100 can be held by the wider portion 140. The wider portion 140 and narrower portion 150 may each form a segment of the strip 100 which extends over about half of the length of the strip 100. The strip 100 is placed between a prepared tooth 110 and the opposing tooth or teeth or dental restoration 120 while the patient is instructed to close their teeth and slide side to side.

The strip/tape/paper may be formed of various flexible substances, such as coated paper, fiber, rubber, or plastic. The marking agent may be one of various forms of color pigments, dyes or inks. For example, the strip/tape/paper may be formed of a micro-fleece paper and the marking agent may be formed of micronized color pigment in an oil-wax emulsion, and this combination may be covered with a bonding agent, coating, or sealant. As a further example, the strip/tape/paper may be formed of fiber-reinforced paper impregnated or coated with hydrophilic waxes and pharmaceutical oils. As a further example, the surface of the strip/tape/paper may be coated with a powered colorant, dye, or pigment.

As shown in FIG. 2, upon closure of the teeth into their natural biting and sliding positions, the marking substance on the surface of or within the strip 100 of occlusal clearance dental marking product is transferred onto at least a portion of the prepared tooth 110 and/or the opposing tooth or teeth or dental restoration 120 (which may be prepared or unprepared). The marking substance is transferred because the occlusal gap or distance between portions of the prepared tooth or teeth and the opposing tooth or teeth or dental restoration is less than the thickness of the occlusal clearance strip/tape/paper, whose thickness is selected based on the dental element being designed or the requirement of the thickness of the material being used for its fabrication. The marking substance is transferred more heavily to those portions of the tooth or teeth which are more forcefully in contact with the strip/tape/paper, i.e., those portions of the tooth or teeth which protrude within the occlusal clearance gap defined by the thickness of the strip/tape/paper. As noted above, the marking substance is provided on both surfaces (180 and 185) of the strip 100.

The occlusal clearance strip/tape/paper is fabricated in specific thicknesses corresponding to the minimum required thicknesses of dental materials used to fabricate dental restorative elements to be installed, e.g., dental crowns, inlays, onlays, dental veneers. By selecting a particular thickness, the dentist can ensure that upon closure of the patient's teeth, markings are transferred from the occlusal clearance strip/tape/paper to areas of inadequate tooth reduction, thus visually aiding the dentist in proper occlusal reduction of the teeth while preparing them for dental restorative elements, such as crowns, inlays, onlays, ¾ crowns, dental veneers, or implant abutments.

For example, a thickness of 1.0 mm may be used to show the minimum reduction required for full cast crowns, porcelain fused to metal crowns with metal occlusal surfaces, or anterior crowns with metal lingual surfaces, or dental veneers. A thickness of 1.5 mm may be used to show the minimum reduction required for full coverage porcelain fused to metal crowns or some ceramic crowns that require less thickness of material. A thickness of 2.0 mm may be used to show an optimum reduction for full coverage porcelain crowns. A thickness of 2.5 mm may also be useful for certain types of porcelain crowns.

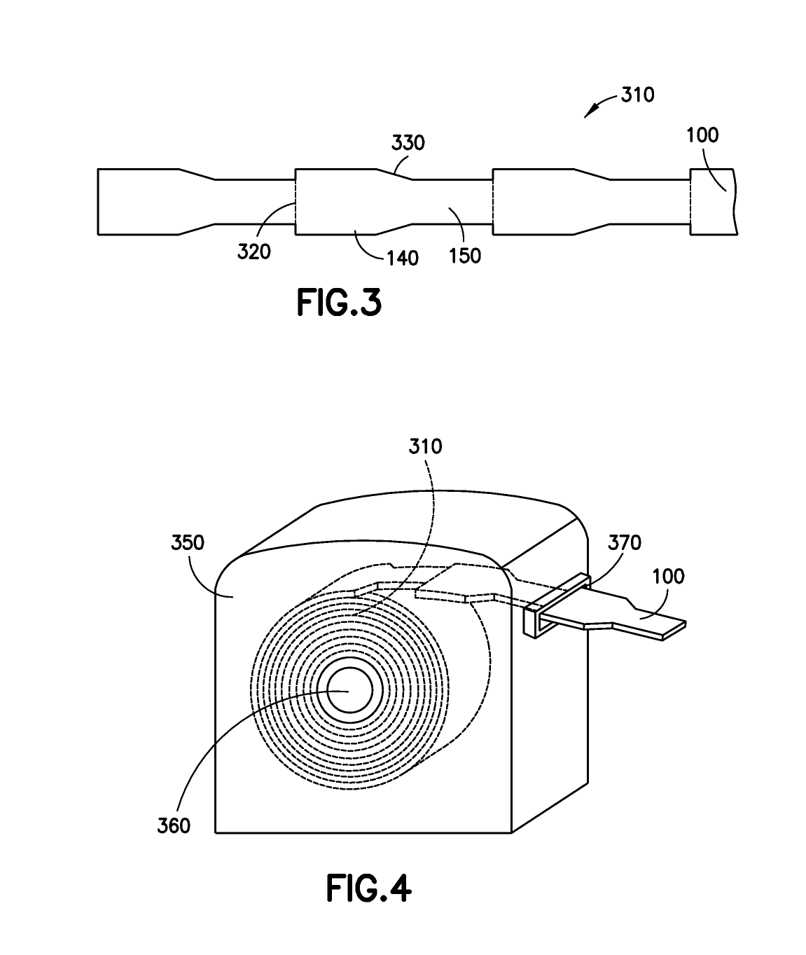

As shown in FIG. 3, the occlusal clearance dental marking product can be provided as small strips 100 which form a continuous roll 310 of dental marking product. The continuous roll 310 can be divided into the individual strips 100, e.g., by using serrated separation boundaries 320. The length of each strip 100 may be about 40 mm to 60 mm in order to make it convenient for the dentist to handle while inserting it into the patient's mouth.

As discussed above, each strip 100 may have a wider portion 140 to be used with wider teeth, such as molars, and a narrower portion 150 to be used with narrower teeth, such as bicuspids or anterior teeth. The wider portion 140 may be between about 5 and 8 mm wide. The narrower portion 150 may be between about 3 and 5 mm wide. The wider and narrower portions may each extend along about one half of the total length of the strip. In one embodiment, the wider portion 140 can be about 7 mm wide (+/−about 0.5 mm) and the narrower portion 150 can be between about 4 mm and about 5 mm.

The portion of the individual strip 100 where the wider portion 140 and narrower portion 150 meet may include a tapered width portion 330 to provide a gradual transition between the wider and narrower portions, which avoids creating a stress point where the strip might tear easily. In alternative embodiments, the width may taper over all, or almost all, of the length of the strip. For example, there may be a relatively short portion at each end of the strip (e.g., between about 10% and about 25% of the total length of the strip) having a constant width, leaving the majority of the length of the strip to have a tapered width. A taper may also be applied at the wider end of the individual strip where the strip meets the narrow end of the next adjoining strip.

As shown in FIG. 4, the continuous roll 310 of occlusal clearance dental marking product may be provided in a dispenser 350, such as, for example a roll dispenser similar to an adhesive tape dispenser. The continuous roll 310 of tape is wound around a dispenser wheel 360 and extends out of the dispenser 350 through an opening 370. The dispenser 350 may include a cutting element near the opening 370 which may facilitate separation of individual strips 100 at the serrated separation boundaries 320.

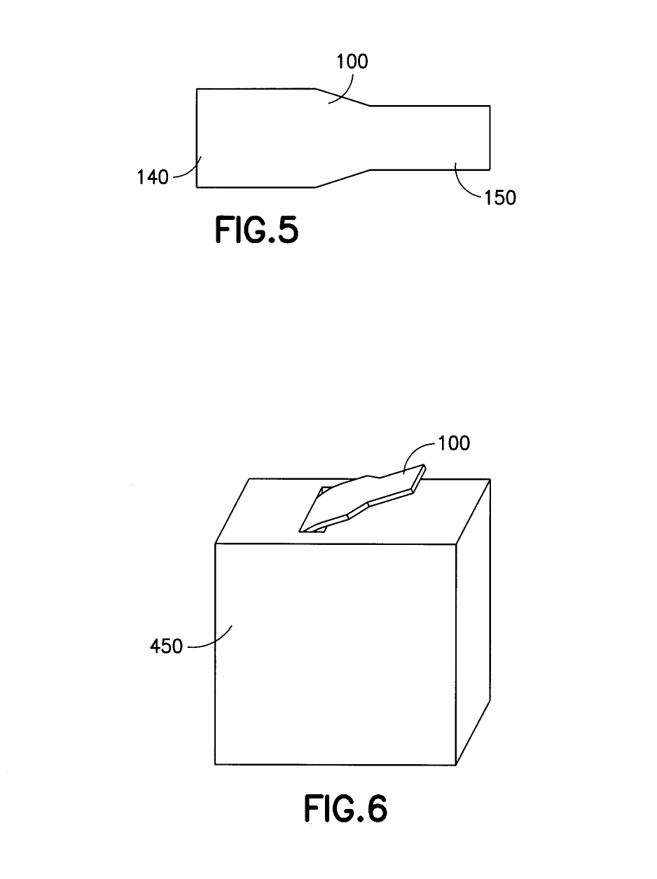

Alternatively, the strips may be provided as individual strips, as shown in FIG. 5, rather than as a continuous roll 310. In such a case, the strips may be stored in a dispenser which is configured to dispense single strip pieces, as shown in FIG. 6. In dispensers of this type, a stack of strips may be stored, along with a forcing element which moves the strips toward the opening as each additional strip is removed.

Although example embodiments have been shown and described in this specification and figures, it would be appreciated by those skilled in the art that changes may be made to the illustrated and/or described example embodiments without departing from their principles and spirit.

What is claimed is:

1. A dental marking product for gauging and marking occlusal clearance between a prepared tooth or teeth and an opposing tooth or teeth or dental restoration to facilitate fabrication and installation of a dental element, the product comprising:
a plurality of flexible strips or tapes or paper which include a marking agent, each strip having:
a narrow portion of a first width at a first end of the strip,
a wide portion of a second width, which is wider than the first width, at a second end of the strip, and
a thickness corresponding to a determined occlusal clearance between the prepared tooth or teeth and the opposing tooth or teeth or dental restoration, the occlusal clearance being determined based on characteristics of the dental element to be fabricated and installed on the prepared tooth or teeth,
wherein the marking agent marks at least portions of the prepared tooth or teeth or the opposing tooth or teeth or dental restoration which protrude into a gap defined by the determined occlusal clearance.

2. The product of claim 1, wherein the plurality of strips are provided in the form of a continuous roll.

3. The product of claim 2, further comprising a dispenser configured to hold the continuous roll and output individual strips from the continuous roll one strip at a time.

4. The product of claim 2, wherein individual strips of the continuous roll are divided by serrations.

5. The product of claim 1, wherein the plurality of strips are provided as separate individual strips.

6. The product of claim 5, further comprising a dispenser configured to hold a stack of the separate individual strips and output the individual strips from the stack one strip at a time.

7. The product of claim 1, wherein the narrow portion and the wide portion each extend over about one half of a length of each strip.

8. The product of claim 1, wherein each strip further comprises a tapered portion between the narrow portion and the wide portion.

9. The product of claim 1, wherein the plurality of strips have a thickness of between 1.0 mm and 2.5 mm.

10. The product of claim 1, wherein the plurality of strips have a thickness of one of 1.0 mm, 1.5 mm, 2.0 mm, and 2.5 mm.

11. The product of claim 10, wherein the plurality of strips is color coded depending upon the thickness of the strips.

12. The product of claim 1, wherein the first width is between about 3 mm and about 5 mm and the second width is between about 5 mm and about 8 mm.

13. The product of claim 1, wherein the first width is between about 4 mm and about 5 mm and the second width is between about 6.5 mm and about 7.5 mm.

14. The product of claim 1, wherein the plurality of strips is formed of at least one of coated paper, fiber-reinforced paper, micro-fleece paper, rubber, and plastic.

15. The product of claim 1, wherein the marking agent is at least one of color pigment, dye, micronized color pigment, powered colorant, and ink.
